(19) United States
(12) Patent Application Publication
(10) Pub. No.: US 2010/0038003 A1
(43) Pub. Date: Feb. 18, 2010

(54) METHOD AND APPARATUS FOR SEALING A WHEEL RIM

(76) Inventor: Jean Carlos Gracia, Vega Baja, PR (US)

Correspondence Address: EUGENIO J. TORRES, 221 PLAZA BUILDING, PONCE DE LEON, SUITE 403, SAN JUAN, PR, 00917, US

(21) Appl. No.: 12/245,319

(22) Filed: Oct. 3, 2008

Related U.S. Application Data
(63) Continuation-in-part of application No. 11/926,585, filed on Oct. 29, 2007.

(51) Int. Cl. B29C 73/00

(52) U.S. Cl. 152/373

(57) ABSTRACT

A method and apparatus to seal a leakage of air from a wheel rim by using a sealer having a first layer made of fibrous material with at least one side adhesive and a second layer of a spreadable sealant applied over the first layer in order to seal failures such as cracks or holes in the wheel rim produced by high stress, corrosion or collisions.

### RELATED APPLICATIONS

This application is a continuation-in-part of non-provisional application Ser. No. 11/926,585 filed on Oct. 29, 2007.

### BACKGROUND OF THE INVENTION

1. Field of the Invention

This invention relates to a method and apparatus for repairing a wheel rim, particularly the apparatus and method to cover the fractures and cracks at the wheel rim in order to avoid the leakage of air from the tire.

2. Discussion of the Background

Vehicle wheel rims are subject to high stresses, corrosion, collisions and other situations which increase the fatigue failure of the rim resulting in cracks and holes created around the wheel rim. Air is leaked out potentially resulting in a flat tire or even an accident. Many manufacturers are oriented in the restoring and reinforcing of the wheel rim in order to increase the life of the wheel. However this treatment can be expensive and most of the time not cost efficient. For example, U.S. Pat. No. 5,638,591 to Lamping discloses a method for restoring the wheel, wherein a vehicle wheel of lightweight alloy is provided with a replaceable beadseat protector which protects the beadseat area of the rim of the wheel from tire abrasion and chafing and subsequent corrosion. The beadseat protector which is provided after the wheel is machined, as disclosed by Lamping, and is not intended to seal cracks but to cover and protect the annular beadseat.

U.S. Pat. No. 4,305,622 to Mitchell discloses a wire wheel sealing structure made of plastic materials applied to the rim by spraying or dripping onto the rotating rim layers of a molten thermoplastic material until a ribbon of the required thickness has been built up. This wire wheel sealing structure as mentioned above is made by applying multiple layers all over the beadseat surface which is time consuming and expensive.

### SUMMARY OF THE INVENTION

The present invention overcomes the disadvantages of the Prior Art by providing a sealing structure that is easy to apply and less expensive.

Accordingly, one object of the invention is to provide an apparatus and method to seal fractures at the wheel rim without machining it.

Another object of the invention is to provide an apparatus and method to seal fractures that is easy to apply.

Yet another object of the present invention is to provide an apparatus and method to seal fractures that is less expensive than the conventional methods.

The invention itself, both as to its configuration and its mode of operation will be best understood, and additional objects and advantages thereof will become apparent, by the following detailed description of a preferred embodiment taken in conjunction with the accompanying drawing.

The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying drawings which are incorporated herein constitute part of the specifications and illustrate the preferred embodiments of the invention.

FIG. 1 is an isometric view of the wheel rim.

FIG. 2 is a view of the tire and the wheel rim.

FIG. 3 is a view of a wheel rim with fractures.

FIG. 4 is a view of a first layer seal over wheel rim fractures.

FIG. 5 is a view of a second layer seal over wheel rim fractures.

FIG. 6 is a view of the repaired wheel rim with tire.

FIG. 7 is a top view of the first layer.

FIG. 8 is an exploded view of section VIII—FIG. 7.

FIG. 9 is a view of a separate made first layer.

FIG. 10 shows a flow chart of the method.

### DESCRIPTION OF THE PREFERRED EMBODIMENT

The present invention relates to a method of sealing fractures on a wheel rim caused by high stress, corrosion, collisions and other situations which increases the fatigue failure of the rim.

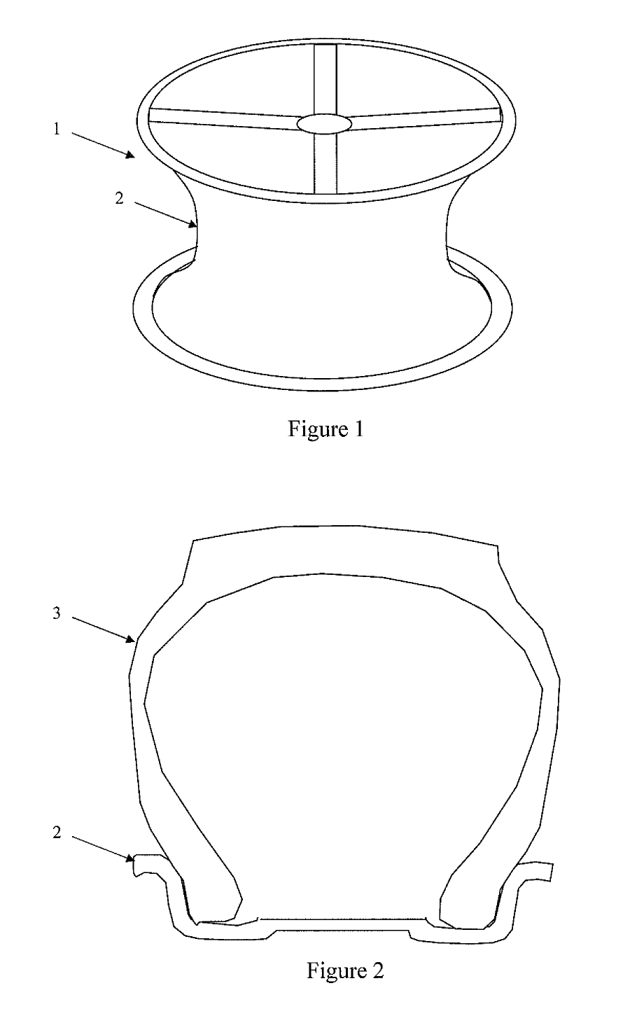

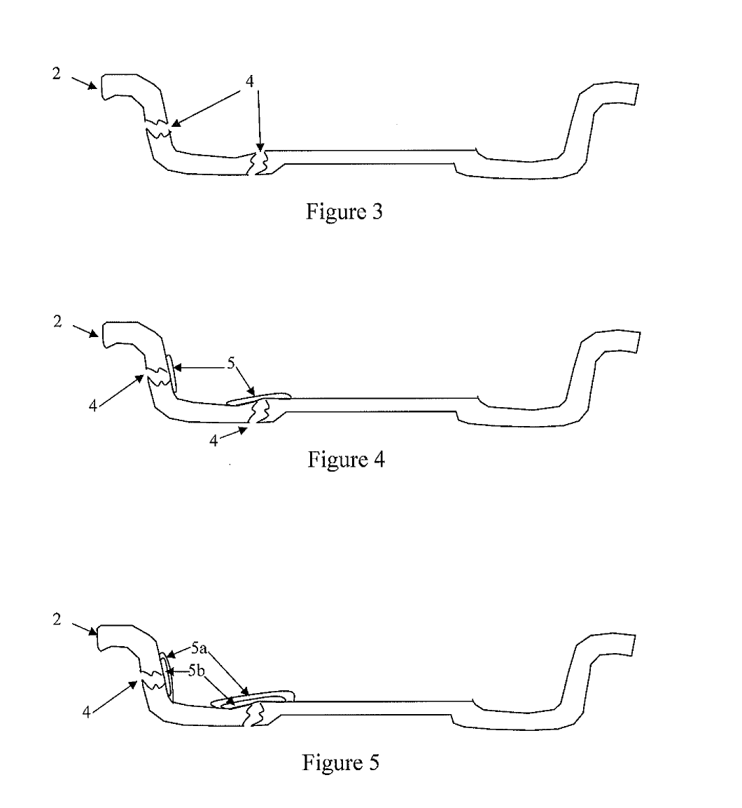

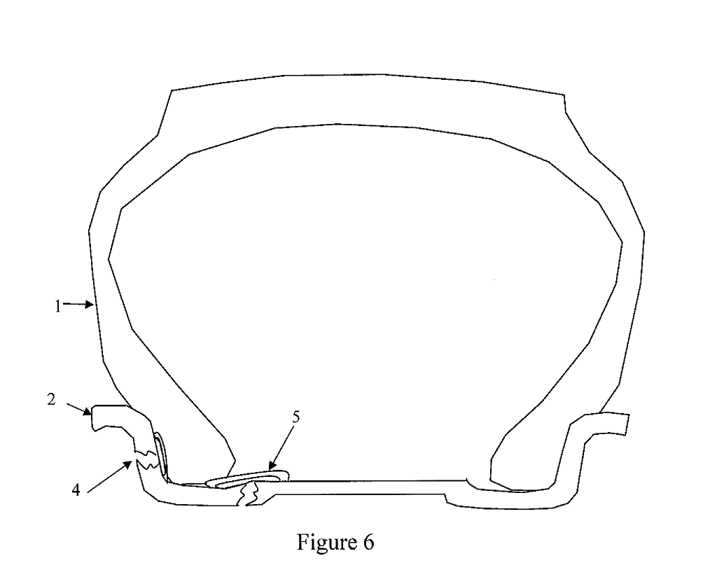

FIG. 1 shows a wheel rim 2, made of a ferrous material such as aluminum and other ferrous materials. Typically the tire is mounted over the rim as show in FIG. 2. While driving, for example, the wheel rim 2 is exposed to high stress, corrosion and collisions which increase the failure of the rim producing fractures or cracks 4 over the rim surface. Consequently a fracture 4 over the rims 2 surface produces air leakage. A solution to detect the air leakage, usually water mixed with liquid soap is sprayed over the wheel rim surface in order to locate the fracture. Usually bubbles are created as the solution contact the pressurize air coming out of the rim from the fracture 4 area. After the failure 4 is located the technician marks the area of the air leakage in order to identify it at the moment he is sealing the fracture. Next the tire 3 is removed from the rim using well know method such as the one use to change tires. Usually because of the use and environment in which the tire and rim in interacting the area around the fracture is filthy. The seal need to contact directly the rim surface therefore the dirt around the failure area is removed using a metallic brush. Removing dirt avoids the sealer's displacement and improves the contact between the sealer 5 and the rim.

The preferred embodiment of the sealer 5 comprises a first layer 5b having adhesive capable of resisting the pressure exert by the air inside the tire. The material of the first layer may vary however the use of fibrous material is preferred on the side which contacts the rim. The first layer 5b is intended to covers the fracture 4 while it is fixed to the rim 2. If needed after the first layer 5b is fixed a second layer 5a is applied over said first layer 4.

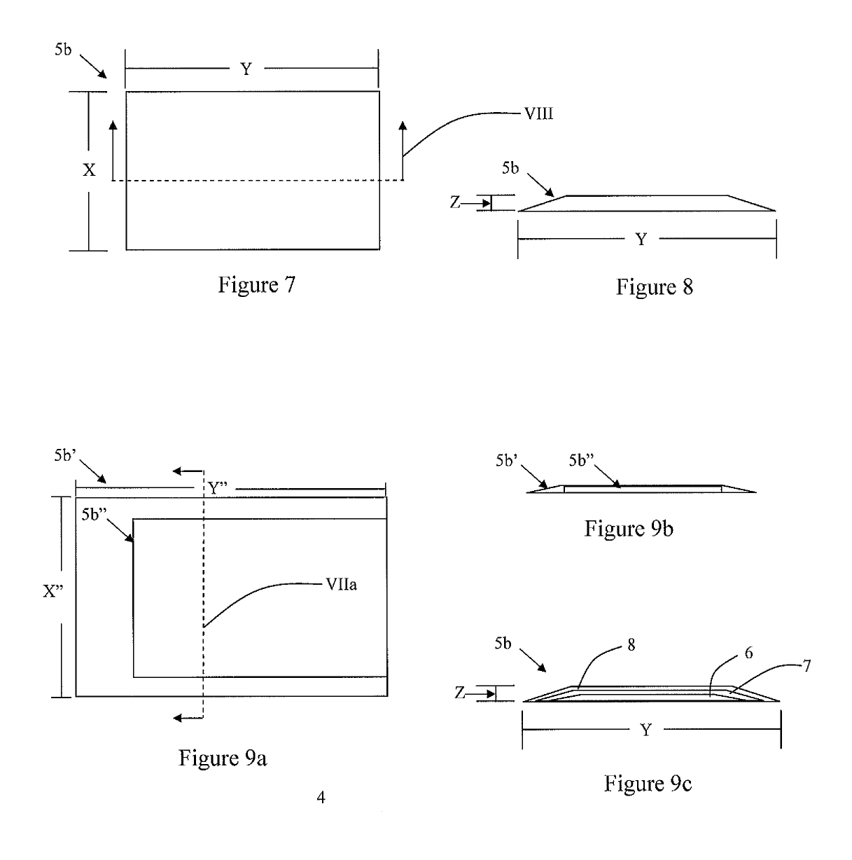

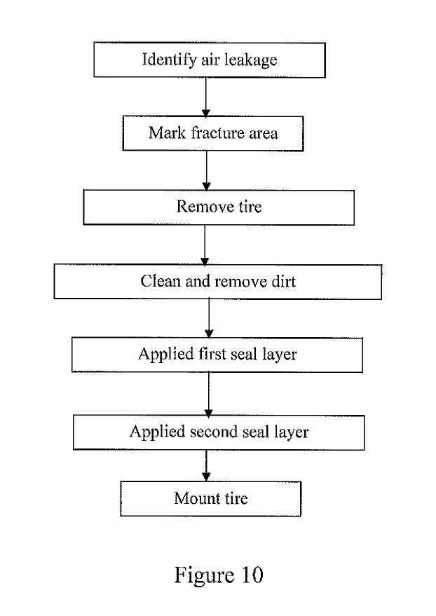

FIGS. 7-9 shows more in detail the sealer 5, especially the first layer 5b having different dimensions (X, Y and Z) and becoming narrower toward the borders. The first layer 5b can be made integrally as a single structure, as in FIG. 7 and FIG. 8, or a combination of multiple sheets 6, 7 and 8 having at least an adhesive side as in FIG. 9.

As mentioned the structure of the first layers 5b becomes narrower at the borders avoiding damage to the sealer 5. Usually when the tire is inflated with air, said tire tends to move in order to adjust with the rim. While moving the area of the tire closer to the sealer pushes the sealer. The use of a good adhesive avoid the movement of the sealer but in case the adhesive fail the structure is equipped with a narrower border that avoid damage to the sealer providing a smooth displacement of the tire over the sealer 5.

When the sealer is a single structure, the thickness over the fracture area is bigger and the border is tapered to provide a narrower border.

On the other hand, as show in FIG. 9, when the first layer 5b is the combination of sheets the border is narrower as a result of the different sizes between the sheets. The use of multiple sheets 5b″,5b′,6-8 and increments in size provides a stronger first layer 5b and avoids damages to the first layer 5b in view of the fact that the sheet 5b″ at the top holds or fixes the sheet 5b′ closer to he fracture or at the bottom better to the rim, and as the thickness decreases at the borders of the first layer 5b an inclined surface is created avoiding first layer's 5b displacement due to pressure gradients or tire displacement that occurs when the tire is being adjusted or inflated. Air pressure or physical tire collision with the first layer can move it easily if the layer does not have a smooth and inclined surface. The first layer's 5b thickness Z may vary depending on the sheet material and adhesive; however thickness and material has to be strong enough to withstand the pressure and temperature. The size of the sheet compare to the previous sheet depends of the material and adhesive; however the preferred range is of at least a 20-40% bigger. Also the sheet at top 5b′ can extend in any direction from the bottom sheet 5b″ but at least one side has a narrower side. Different sheet material might be use per layer however at least one of the sheet 5b″, 5b′ should withstand higher pressure.

The second layer 5a of sealer 5 is a spreadable sealant which is applied over the first layer 5b if necessary helping to prevent the first layer's 5b displacement and leakage of air. After the second layer 5a is applied the technician waits until the sealants dry and mounts the tire.

While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

1. A sealer for sealing a wheel rim fracture comprising: a first layer having an adhesive side wherein the first layer thickness decrease toward said first layer border.

2. A sealer for sealing a wheel rim fracture as in claim 1, wherein said sealer further comprises a second layer made of a spreadable sealant which is applied over the first layer.

3. A sealer for sealing a wheel rim fracture as in claim 1, wherein said first layer is made of a fibrous material.

4. A sealer for sealing a wheel rim fracture as in claim 1, wherein said first layer is made with multiple sheets having different sizes, wherein the smallest one is closer to the rim fracture.

5. A sealer for sealing a wheel rim fracture comprising:
a first layer having an adhesive side
wherein said first layer at least two sheets, and
wherein said sheet have different sizes.

6. A sealer for sealing a wheel rim fracture as in claim 5, wherein the thickness decrease toward at least one of the first layer border.

7. A sealer for sealing a wheel rim fracture as in claim 5, wherein said sealer further comprises a second layer made of a spreadable sealant which is applied over the first layer.

8. A sealer for sealing a wheel rim fracture as in claim 5, wherein at least one of the sheets is made of a fibrous material.

9. A sealer for sealing a wheel rim fracture as in claim 5, wherein the sheets are made of different material.

10. A sealer for sealing a wheel rim fracture as in claim 5, wherein the smallest sheet is closer to the rim fracture.
